(19) United States
(12) Patent Application Publication
(10) Pub. No.: US 2025/0231276 A1
(43) Pub. Date: Jul. 17, 2025

(54) RADAR MODULE ASSEMBLY

(71) Applicant: HL KLEMOVE CORP., Incheon (KR)

(72) Inventor: Han-Yeol YU, Incheon (KR)

(21) Appl. No.: 19/015,486

(22) Filed: Jan. 9, 2025

(30) Foreign Application Priority Data
Jan. 11, 2024 (KR) 10-2024-0004570

(51) Int. Cl. G01S 7/03; G01S 7/02; H01Q 1/22; H01Q 1/42

(52) U.S. Cl. CPC G01S 7/032; G01S 7/027; H01Q 1/2283; H01Q 1/42

(57) ABSTRACT

A radar module assembly includes a housing having an internal space therein; an antenna module accommodated inside the internal space of the housing; a substrate disposed to face one surface of the antenna module and disposed inside the internal space of the housing and having an antenna chip mounted thereon for transmitting and receiving a signal through the antenna module; and a radome coupled to the housing to cover the internal space of the housing on the other surface of the antenna module.

### CROSS-REFERENCE TO RELATED APPLICATION

This application claims priority to and the benefit of Korean Patent Application No. 10-2024-0004570, filed on Jan. 11, 2024, the disclosure of which is incorporated herein by reference in its entirety.

### FIELD

The present disclosure generally relates to a radar module assembly, and more particularly, to a radar module assembly in which an antenna module is embedded.

### BACKGROUND

Recently, antennas used in radar have developed from a printed circuit board (PCB) type to a waveguide type.

Radar including waveguide-type antennas has a complex structure in which an antenna structure formed so that an antenna slot is connected to a waveguide is combined with a substrate that generates an RF signal. Accordingly, there is a need for developing an antenna module with a waveguide having a simpler structure.

In addition, recently, an antenna chip that radiates radio waves by direct feeding method other than indirect feeding method of radar that radiates radio waves through a radio frequency (RF) PCB has been developed, and it is necessary to develop a radar module assembly capable of applying such an indirect feed method and a direct feed method.

In addition, it is necessary to develop a radar module assembly having a more compact structure that is easy to couple an antenna module to a housing of a radar in order to reduce the size and weight of a radar assembly installed in a device where a radar is used, such as a vehicle.

### SUMMARY

Some embodiments of the present disclosure may provide a radar module assembly having a more compact structure that is easy to couple an antenna module to a housing of a radar.

Certain embodiments of the present disclosure may provide a radar module assembly with a more compact structure and a direct feeding structure.

Some embodiments of the present disclosure may provide a radar module assembly capable of transmitting signals in an indirect feed structure while having a more compact structure.

Certain embodiments of the present disclosure may provide a radar module structure capable of directly coupling an antenna module, a substrate on which a chip is mounted, and a substrate support frame supporting the substrate to a housing of a radar structure.

Some embodiments of the present disclosure may provide a radar module structure having an antenna chip support structure capable of securely supporting an antenna chip mounted on a substrate and generating a radar signal inside a housing.

The objects of the present disclosure are not limited to the above-described objects, and other objects that are not mentioned will be able to be clearly understood by those skilled in the art to which the present disclosure pertains from the following description.

According to an aspect of the present disclosure, there is provided a radar module assembly including: a housing having a first internal space therein; an antenna module accommodated inside the first internal space of the housing; a substrate coupled to one surface of the antenna module and accommodated inside the first internal space of the housing and having an antenna chip mounted thereon for transmitting and receiving signals through the antenna module; and a radome coupled to the housing to cover the first internal space of the housing on the other surface of the antenna module.

In this case, the antenna chip may be a single chip in which RFIC and MCU are integrated.

In this case, the antenna chip may be mounted on the opposite surface of one surface of the substrate to which the antenna module is coupled, and a feeding hole may be formed in the substrate to directly feed the signals from the antenna chip to the antenna module.

In this case, the substrate may be formed of a PCB substrate made of FR4 material.

In this case, the antenna module may include an antenna module body having a waveguide formed therein, and one end of the waveguide may be connected to a waveguide connection hole formed in the antenna module body to be connected to the feeding hole, and the other end of the waveguide may be connected to an antenna slot formed on one surface facing the radome.

In this case, the feeding hole, the waveguide, and the antenna slot may be formed in a plurality, and some of the feeding hole, the waveguide, and the antenna slot may be connected to the chip to transmit signals, and the other may be connected to the chip to receive signals.

In this case, the antenna module body may be formed in a plate shape made of synthetic resin, and a plating layer may be formed on the inner surface of the waveguide and the outer surface of the antenna module body.

In this case, the antenna chip may be mounted on one surface of the substrate facing the antenna module.

In this case, a gap maintaining portion that is thicker than a thickness of the antenna chip may be formed on one surface of the antenna module facing the substrate to separate a gap between the antenna module and the substrate.

Meanwhile, the substrate may include a RF PCB substrate facing the antenna module and a FR4 PCB substrate stacked on the RF PCB substrate.

In this case, a plurality of feeding lines are formed on the RF PCB substrate, and a transmission terminal for transmitting signals or a reception terminal for receiving signals may be formed at each end side of the plurality of feeding lines.

In this case, the antenna module may include an antenna module body having a waveguide formed therein, and one end of the waveguide may be connected to the transmission terminal or the reception terminal, and the other end of the waveguide may be connected to an antenna slot formed on one surface facing the radome.

Meanwhile, the radar module assembly may include a substrate support frame for supporting the substrate in the first internal space, and a fastening member for coupling the antenna module and the substrate to the substrate support frame.

In this case, the substrate support frame may include a bottom portion that has a plate shape in contact with an inner surface of the first internal space of the housing; and a sidewall portion protruding toward the substrate along a circumference of the bottom portion, and wherein an edge portion of the substrate is supported in contact with the sidewall portion.

In this case, a protrusion portion that protrudes from the bottom portion and supports the substrate or the antenna chip may be formed on the substrate support frame.

In this case, the fastening member may be formed to couple the antenna module, the substrate, and the substrate support frame to the inside of the first internal space of the housing.

In this case, a position fixing groove may be formed on one side portion of the antenna module, the substrate, and the substrate support frame, and a position fixing protrusion corresponding to the position fixing groove may be formed on a sidewall portion of the first internal space of the housing.

In this case, a terminal unit is formed at one side of the first internal space of the housing, and one end of the terminal portion protrudes to an external terminal connection portion formed outside the housing, and the other end of the terminal portion is formed to be electrically connected to the substrate.

According to another aspect of the present disclosure, there is provided a radar module assembly including; a housing having a first internal space therein; an antenna module assembly accommodated inside the first internal space of the housing; and a radome coupled to the housing to cover the first internal space of the housing, wherein the antenna module assembly includes an antenna module; a substrate coupled to one surface of the antenna module and accommodated inside the first internal space of the housing and having an antenna chip mounted thereon for transmitting and receiving signals through the antenna module; and a substrate support frame for supporting the substrate in the first internal space, wherein the antenna module, the substrate, and the substrate support frame are formed to be assembled by a predetermined fastening member.

In this case, the antenna chip may be a single chip in which RFIC and MCU are integrated.

In this case, the antenna chip may be mounted on the opposite surface of one surface of the substrate to which the antenna module is coupled, and a feeding hole may be formed in the substrate to directly feed the signals from the antenna chip to the antenna module.

In this case, the substrate may be formed of a PCB substrate made of FR4 material.

In this case, the antenna module may include an antenna module body having a waveguide formed therein, wherein one end of the waveguide may be connected to a waveguide connection hole formed in the antenna module body to be connected to the feeding hole, and the other end of the waveguide may be connected to an antenna slot formed on one surface facing the radome.

Meanwhile, the antenna chip may be mounted on one surface of the substrate facing the antenna module.

In this case, the substrate may include a RF PCB substrate facing the antenna module and a FR4 PCB substrate stacked on the RF PCB substrate.

In this case, a plurality of feeding lines may be formed on the RF PCB substrate, and a transmission terminal for transmitting signals or a reception terminal for receiving signals may be formed at each end side of the feeding lines.

In this case, the antenna module may include an antenna module body having a waveguide formed therein, one end of the waveguide may be connected to a transmission terminal or reception terminal, and the other end of the waveguide may be connected to an antenna slot formed on one surface facing the radome.

In this case, the substrate support frame may include a bottom portion that has a plate shape in contact with an inner surface of the first internal space of the housing; and a sidewall portion protruding toward the substrate along a circumference of the bottom portion, and wherein an edge portion of the substrate may be supported in contact with the sidewall portion.

In this case, the fastening member may be formed to couple the antenna module, the substrate, and the substrate support frame to the inside of the first internal space of the housing.

In this case, a position fixing groove may be formed on one side portion of the antenna module, the substrate, and the substrate support frame, and a position fixing protrusion corresponding to the position fixing groove may be formed on a sidewall portion of the first internal space of the housing.

In this case, a terminal unit may be formed at one side of the first internal space of the housing, and one end of the terminal portion may protrude to an external terminal connection portion formed outside the housing, and the other end of the terminal portion may be formed to be electrically connected to the substrate.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of a radar module assembly according to a first embodiment of the present disclosure.

FIG. 2 is an exploded perspective view of a radar module assembly according to the first embodiment of the present disclosure.

FIG. 3 is an exploded top perspective view of an antenna module of a radar module assembly according to the first embodiment of the present disclosure,

FIG. 4 is an exploded bottom perspective view of an antenna module of a radar module assembly according to the first embodiment of the present disclosure.

FIG. 5 is a cross-sectional view of a radar module assembly according to the first embodiment of the present disclosure.

FIG. 6 is a schematic configuration diagram for describing an operation of a radar module assembly according to the first embodiment of the present disclosure.

FIG. 7 is a perspective view of a radar module assembly according to a second embodiment of the present disclosure.

FIG. 8 is an exploded perspective view of the radar module assembly according to the second embodiment of the present disclosure.

FIG. 9 is an exploded top perspective view of an antenna module of a radar module assembly according to the second embodiment of the present disclosure.

FIG. 10 is an exploded bottom perspective view of an antenna module of a radar module assembly according to the second embodiment of the present disclosure.

FIG. 11 is a cross-sectional view of a radar module assembly according to the second embodiment of the present disclosure.

FIG. 12 is a schematic configuration diagram for describing an operation of the radar module assembly according to the second embodiment of the present disclosure.

### DETAILED DESCRIPTION

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used In the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

The words and terms used in the present specification and the claims are not interpreted as limited to ordinary or dictionary meanings, but should be interpreted as meanings and concepts consistent with the technical idea of the present invention according to the principle in which the inventor may define the terms and concepts in order to best describe their invention.

Therefore, the embodiments described in the present specification and the configurations illustrated in the drawings correspond to a preferred embodiment of the present invention and do not all represent the technical idea of the present invention, so the corresponding configurations may be various equivalents and modifications to replace them at the time of filing the present invention.

A waveguide antenna structure according to an embodiment of the present disclosure may include a base layer having a feeding hole to allow direct feeding to an waveguide and an antenna layer for transmitting or receiving radio frequency (RF) signals transmitted from the waveguide, by forming a conduit line through routing in a stacked PCB, and forming a via hole in both sides of the conduit line to form the waveguide.

Accordingly, an waveguide antenna structure according to an embodiment of the present disclosure may be configured to be directly fed while having a simple structure, thereby reducing signal loss. Hereinafter, a waveguide antenna structure according to an embodiment of the present invention will be described in detail with different drawings. In this specification, the thicknesses of each layer of an waveguide antenna structure is exaggerated for illustration purposes only.

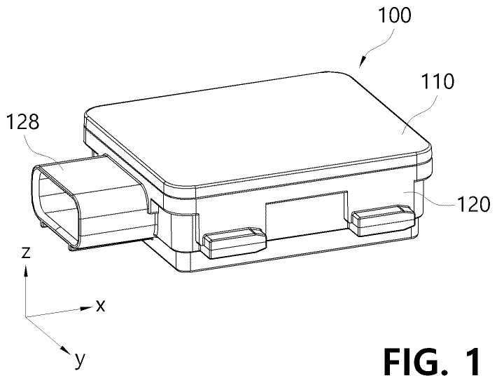

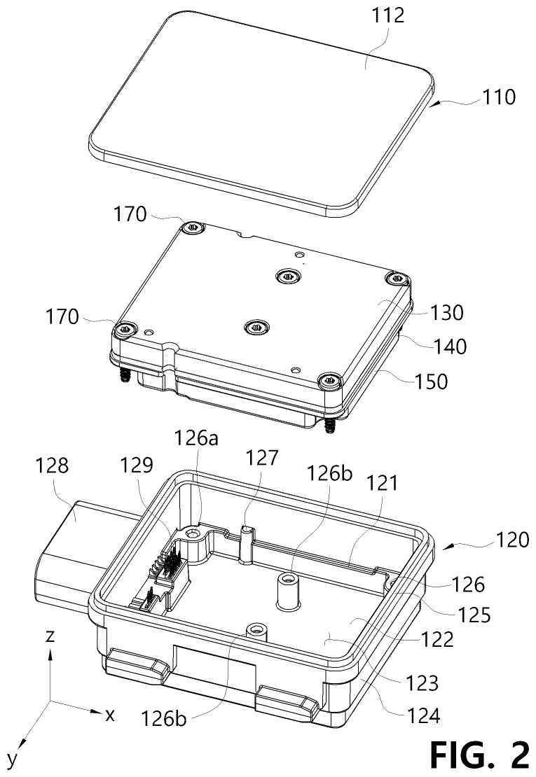

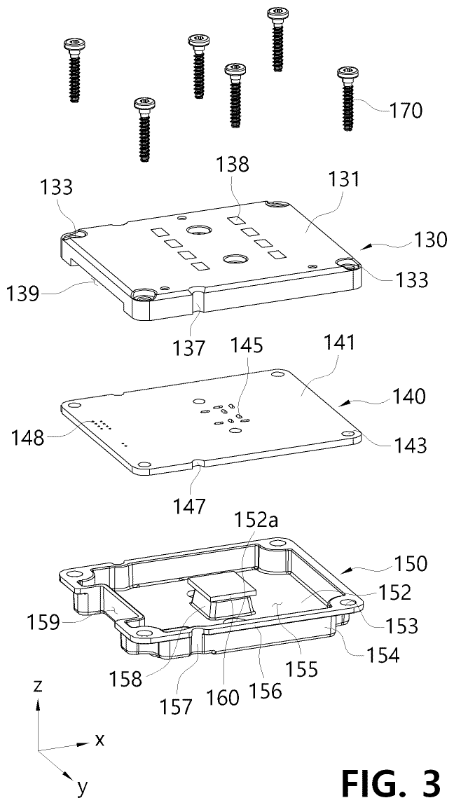

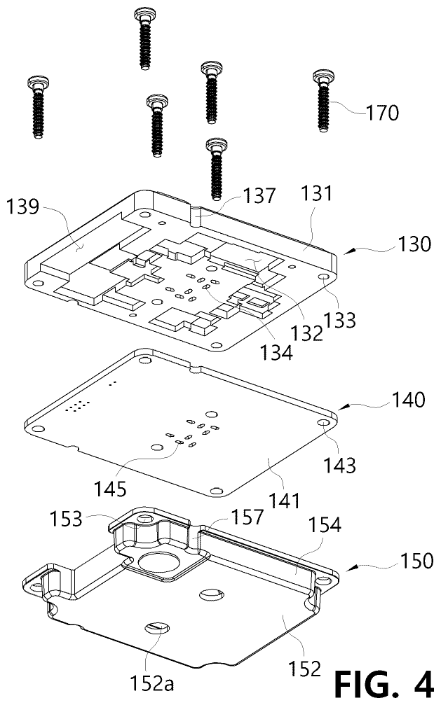

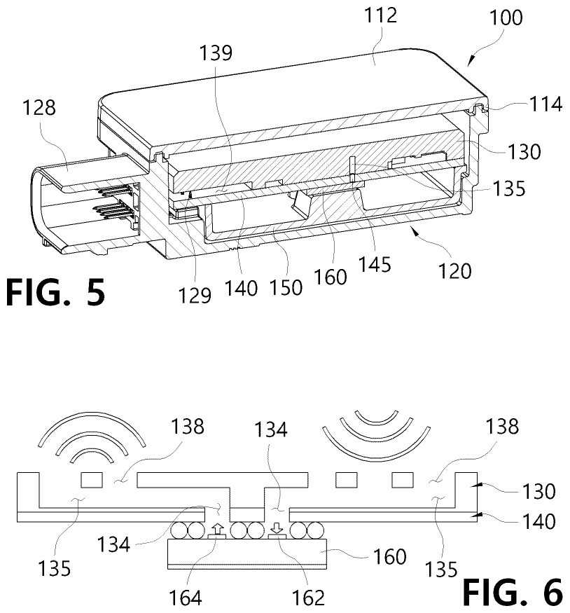

FIG. 1 is a perspective view of a radar module assembly according to a first embodiment of the present disclosure. FIG. 2 is an exploded perspective view of a radar module assembly according to the first embodiment of the present disclosure. FIG. 3 is an exploded top perspective view of an antenna module of a radar module assembly according to the first embodiment of the present disclosure. FIG. 4 is an exploded bottom perspective view of an antenna module of a radar module assembly according to the first embodiment of the present disclosure. FIG. 5 is a cross-sectional view of a radar module assembly according to the first embodiment of the present disclosure. FIG. 6 is a schematic configuration diagram for describing an operation of the radar module assembly according to the first embodiment of the present disclosure.

Referring to FIGS. 1 to 6, a radar module assembly 100 according to a first embodiment of the present disclosure may include a housing 120, an antenna module 130, a substrate 140, a substrate support frame 150, and a radome 110.

Referring to FIGS. 1 and 2, the antenna module 130, the substrate 140, and the substrate support frame 150 of the radar module assembly 100 according to the first embodiment of the present disclosure may be modularized by being fastened and assembled using a faster or fastening member 170 such as a bolt. In other words, the antenna module 130, the substrate 140, and the substrate support frame 150 of the radar module assembly 100 may be assembled to be a single module using the fastener 170.

The antenna module 130, the substrate 140, and the substrate support frame 150 which are assembled and modularized to be a single module may be referred to as an antenna module assembly. The modular antenna module 130, the substrate 140, and the substrate support frame 150 may be embedded in the radome 110 and the housing 120 forming the outer structure of the radar module assembly 100.

For example, in an embodiment of the present disclosure, the housing 120 may have a substantially hexahedral shape, and may be formed of a synthetic resin material such as plastic.

Referring to FIG. 2, the housing 120 includes a substantially rectangular plate-shaped bottom/base portion 122 forming a bottom surface of the housing 120 and a sidewall portion 124 extending in a z-axis direction of FIG. 2 (e.g. an upward or downward direction in FIG. 2) and forming four sidewalls in four sides or corners of the bottom/base portion 122.

A radome coupling portion 125 protruding upwardly to be coupled to a side coupling portion 114 of the radome 110 is formed to protrude from the upper end of the sidewall portion 124 of the housing 120. The protrusion of the radome coupling part 125 may be continuously formed along an upper circumference of the housing sidewall portion 124 so that the inside of the housing 120 can be watertight.

A first internal space 123 in which the antenna module 130, the substrate 140, and the substrate support frame 150 may be disposed is formed inside the housing 120.

One or more position fixing protrusions 127 are formed on the inner surface of the sidewall portion 124 inside the housing 120 so that the antenna module 130, the substrate 140, and the substrate support frame 150 are securely positioned in the first internal space 123 by being supported by the position fixing protrusions 127 without being movable.

For example, the position fixing protrusions 127 are formed in a bar shape extending in the z-axis direction in FIG. 2 and protrude from the inner surface of the housing 120.

Position fixing grooves 137, 147, and 157 are formed on the side surfaces of the antenna module 130, the substrate 140, and the substrate support frame 150, respectively, corresponding to the position where the position fixing protrusions 127 of the housing 120 are formed.

Accordingly, while the antenna module 130, the substrate 140, and the substrate support frame 150 are disposed in the first internal space 123 of the housing 120, the position fixing grooves 137, 147, and 157 are positioned to be in contact with the position fixing protrusions 127, and the antenna module 130, the substrate 140, and the substrate support frame 150 may be stably fixed in the first internal space 123 of the housing 120.

A terminal unit 129 is located at one side of the first internal space 123 of the housing 120.

The terminal unit 129 includes a plurality of pins as shown in FIG. 2, and first portions (e.g. first end portions) of the plurality of pins of the terminal unit 129 protrude upward from the first internal space 123 of the housing 120 (e.g. one side end of the first internal space 123 of the housing 120 with respect to the x-axis direction in FIG. 2).

Second portions (e.g. second end portions) of the plurality of pin of the terminal unit 129 protrude outwardly from the housing 120 through an external terminal connection portion 128 as shown in FIG. 5.

According to an embodiment of the present disclosure, when the antenna module 130, the substrate 140, and the substrate support frame 150 are mounted in the first internal space 123 of the housing 120, a terminal coupling hole 148 of the substrate 140 may be coupled to the terminal unit 129, and accordingly, the substrate 140 may be electrically connected to an external device located outside the housing 120 through the external terminal connection portion 128.

A fastner coupling groove or fastening member coupling groove 126a is formed at four corners of the first internal space 123 of the housing 120 so that the fastener or fastening member 170 for coupling the antenna module 130, the substrate 140, and the substrate support frame 150 may be stably coupled to the inside of the first internal space 123 of the housing 120.

In this case, according to an embodiment of the present disclosure, one or more fastner coupling protrusions or fastening member coupling protrusions 126b are formed to protrude from the bottom surface 122 of the housing 120.

In an embodiment of the present disclosure, the fastening member 170 penetrating four corners of the antenna module 130, the substrate 140, and the substrate support frame 150 may be coupled to the fastening member coupling groove 126a formed at four corners inside the first internal space 123 of the housing 120.

In addition, the fastner or fastening member 170 penetrating the antenna module 130, the substrate 140, and the substrate support frame 150 may be also coupled to one or more fastner coupling protrusions or fastening member coupling protrusions 126b protruding from the bottom surface 122 of the housing 120.

In this case, each of the fastening member coupling grooves 126a formed at the four corners of the first internal space 123 of the housing 120 is formed with a hole into which the fastner or fastening member 170 may be inserted at a height spaced at a predetermined height upward from the bottom surface 122 of the housing 120, and stepped portions 121 are formed on the inner surface of the sidewall portions 124 of the housing 120 at a same height as an end of the fastner coupling grooves or fastening member coupling grooves 126a.

The stepped portions 121 support the edge portion 156 formed along the outer circumference of the substrate support frame 150 in a state where the substrate support frame 150 is coupled to the first internal space 123 of the housing 120. Accordingly, the substrate support frame 150 may be stably supported without moving in the first internal space 123 of the housing 120.

In addition, the outer surface of the substrate support frame 150 may be formed in a quadrangular cross-section, and may be formed in a shape substantially corresponding to the inner surface of the sidewall portion 124 of the first internal space 123 of the housing 120.

Accordingly, the outer surface of the substrate support frame 150 may be disposed adjacent to the inner surface of the sidewall portion 124 of the first internal space 123 of the housing 120 in a state in which the substrate support frame 150 is inserted and fixed in the first internal space 123 of the housing 120. Accordingly, the radar module assembly 100 may have a more compact structure.

Meanwhile, in an embodiment of the present disclosure, one or more fastener coupling protrusions or fastening member coupling protrusions 126b protruding from the bottom surface portion 122 of the housing 120 are located on both sides of the antenna chip 160 around or adjacent to the antenna chip 160. Accordingly, the antenna chip 160 may be firmly coupled with the substrate 140 and the antenna module 130 in a state in which the antenna module 130, the substrate 140, and the substrate support frame 150 are coupled to the inside of the housing 120, so that the radar signal may be transmitted and received stably.

Referring to FIGS. 2 and 5, the radome 110 may be a cover covering the antenna module 130, and the radome 110 may have an electrical insulating material.

In an embodiment of the present disclosure, the radome 110 includes a top plate portion 112 having a substantially rectangular shape of a top surface oriented in the z-axis direction as shown in FIG. 2 and disposed on the upper surface of the antenna module 130 provided inside the radar module assembly 100.

A side coupling portion 114 is formed along the outer edge of the upper plate portion 112. The side coupling portion 114 has a groove opened in a downward direction to be coupled with a radome coupling portion 125 of the housing 120.

The radome 110 may be designed with a material, a size, and a shape so that signals may be stably transmitted and received from the outside of the radar module assembly 100 through the antenna module 130.

Referring to FIGS. 3 and 4, in an embodiment of the present disclosure, the antenna module 130, the substrate 140, and the substrate support frame 150 are disposed inside the first internal space 123 of the housing 120 in a stacked manner.

The antenna module 130, the substrate 140, and the substrate support frame 150 may be disposed inside the first internal space 123 of the housing 120 in a state where the antenna module 130, the substrate 140, and the substrate support frame 150 are integrally coupled by the fastner or fastening member 170. Alternatively, the antenna module 130, the substrate 140, and the substrate support frame 150 and the housing 120 may be coupled by the fastening member 170 at the same time when coupled to the first internal space 123 of the housing 120.

Referring to FIGS. 3 to 6, the antenna module 130 according to an embodiment of the present disclosure may include an antenna module body 131 which is a rectangular plate-shaped structure. For example, the antenna module body 131 may be formed of a synthetic resin material such as plastic, but any material can be used for the antenna module body 131. In this case, a plating layer may be formed on the outer surface of the antenna module body 131.

In an embodiment of the present disclosure, as shown in FIG. 3, the plurality of antenna slots 138 are formed on the upper surface of the antenna module 130.

Referring to FIG. 6, a plurality of antenna slots 138 are connected to a waveguide 135 positioned inside the antenna module 130 and a waveguide connection hole 134 formed in a lower surface of the antenna module 130.

For instance, the antenna slots 138 may have eight antenna slots, and four of the eight antenna slots 138 may be used for transmission, and the remaining four of the eight antenna slots 138 may be used for reception. The shape, number, and position of the antenna slot may vary depending on an antenna design of the radar module assembly 100.

Referring to FIG. 4, the accommodation groove 132 is formed on the lower surface of the antenna module 130 which is a surface adjacent to the substrate 140. The accommodation groove 132 may be formed to have various depths and shapes on the lower surface of the antenna module 130 to avoid interference with a plurality of electronic components provided in the substrate 140.

According to an embodiment of the present disclosure, the accommodation groove 132 for avoiding interference with the electronic components mounted on or included in the substrate 140 is formed on a surface of the antenna module 130 adjacent to the substrate 140, thereby reducing the overall thickness of the antenna module 130, and thus manufacturing the antenna module 130 with a more compact size.

In an embodiment of the present disclosure, the size and positional shape of the accommodation groove 132 may be designed in various ways in consideration of the height of the components mounted on or included in the substrate 140, and for this, the antenna module 130 may be formed by a method of stacking a plurality of plate members made of plastic. However, the method of manufacturing the antenna module 130 is not limited thereto, and, for instance, the antenna module 130 may be manufactured using 3D printing. In addition, the antenna module 130 may be manufactured in various known methods.

Meanwhile, referring to FIGS. 3, 4, and 6, the antenna slot 138, the waveguide 135, and the waveguide connection hole 134 are connected to a feeding hole 145 of the substrate 140. A metal plating layer is formed inside the antenna slot 138, the waveguide 135, and the waveguide connection hole 134 to smoothly transmit and receive signals when the signals passing through the waveguide 135 are transmitted to the outside of the radar module assembly 100 through the antenna slot 138 from the feeding hole 145 or received from the outside of the radar module assembly 100.

Referring to FIGS. 3 and 4, the fastening hole 133 is formed to penetrate in the upper and lower directions (e.g. a direction perpendicular to a plane of the antenna module 130) so that the fastner or fastening member 170 may be coupled to four corners of the antenna module 130 and a central portion where the antenna chip 160 is located.

In addition, as shown in FIG. 3, a terminal interference prevention groove 139 is formed on the outer side of the antenna module 130 in the x-axis direction to prevent interference in a state in which the terminal unit 129 is coupled to the substrate 140.

Meanwhile, as shown in FIG. 3, position fixing grooves 137 are formed on both sides of the antenna module 130 to face each other. For instance, the position fixing grooves 137 are arranged to be aligned with each other in an y-axis direction of FIG. 3.

Meanwhile, in an embodiment of the present disclosure, referring to FIGS. 3 and 4, the substrate 140 coupled to the lower portion of the antenna module 130 may be a printed circuit board (PCB) substrate made of fiberglass-reinforced epoxy laminate material (FR4) material. In an embodiment of the present disclosure, the substrate 140 coupled to the lower portion of the antenna module 130 is formed of the FR4 material, thereby reducing costs for manufacturing the radar and simplifying the structure of the radar module assembly 100.

Meanwhile, according to an embodiment of the present disclosure, a plurality of feeding holes 145 are formed in a central portion of the substrate 140. The plurality of feeding holes 145 may be configured to form paths for transmitting or receiving signals fed directly from the antenna chip 160, and in the present embodiment, for example, eight feeding holes 145 are formed to be connected to the antenna slots 138, respectively.

Referring to FIG. 3, terminal coupling holes 148 for being coupled to the terminal unit 129 are formed on one end portion of the substrate 140 (e.g. an end portion in the x-axis direction of FIG. 3). In addition, the position fixing grooves 147 are formed on both sides corresponding to the position fixing grooves 137 of the antenna module 130, The position fixing grooves 147 are arranged to be aligned with each other in an y-axis direction of FIG. 3.

Meanwhile, referring to FIGS. 3, 5, and 6, the antenna chip 160 is mounted on one surface of the substrate 140, for example, a lower surface of the substrate 140 in FIG. 3. In this case, according to an embodiment of the present disclosure, the antenna chip 160 mounted on the lower surface of the substrate 140 may be a single chip in which a Radio Frequency Integrated Circuit (RFIC) and a microcontroller unit (MCU) are integrated, and may be a radar system on chip (SoC). Accordingly, the antenna chip 160 according to an embodiment of the present disclosure may transmit and receive signals using a direct feeding method.

According to an embodiment of the present disclosure, the antenna chip 160 configured to transmit and receive signals by the direct feeding method is mounted on the substrate 140 (for example, a woven fiberglass substrate such as a FR4 material substrate), the feeding hole 145 is formed in the substrate 140, and then the antenna module 130 having the antenna waveguide 135 connected to the feeding hole 145 is coupled to the substrate 140, so that the radar module assembly 100 can have.

In addition, the radar module assembly 100 according to an embodiment of the present disclosure forms a radar module by the direct feeding method, so the sensing range of radar can be widened and more accurate signal transmission and reception can be performed.

According to an embodiment of the present disclosure, the substrate support frame 150 is provided to support the substrate 140 and the antenna chip 160 mounted on the substrate 140.

Referring to FIGS. 3 and 4, the substrate support frame 150 includes a bottom/base portion 152 formed of a rectangular plate structure or member to form a bottom surface and a sidewall portion 154 protruding from edges or four corners of the bottom portion 152 in the z-axis direction to form a side wall or surface of the radar module assembly 100.

An edge portion 156 is formed at an upper end portion of the sidewall portion 154. The edge portion 156 extends in a direction perpendicular to the sidewall portion 154, such as an y-direction in FIG. 3. In an embodiment of the present disclosure, the substrate 140 is coupled to the substrate support frame 150 by the fastner or fastening member 170 while an edge portion of the substrate 140 is in contact with the edge portion 156 of the substrate support frame 150.

Fastening holes 153 are formed at the edge portion 156 of the substrate support frame 150, for example, four corners of the substrate support frame 150 where the edge portion 156 of the substrate support frame 150 is formed, so that the fastening member 170 may be coupled through the fastening holes 153 of the substrate support frame 150.

Meanwhile, one or more through holes 152a are formed at a central portion of the bottom portion 152 of the substrate support frame 150 so that the fastening member coupling protrusion 126b formed at the bottom portion of the housing 120 protrudes and penetrates through the through hole 152 of the substrate support frame 150.

Accordingly, in an embodiment of the present disclosure, the bottom portion 152 of the substrate support frame 150 may be mounted inside the first internal space 123 of the housing 120, and be fixed to and be in contact with the bottom portion 122 of the housing 120.

In an embodiment of the present disclosure, the antenna chip 160 mounted on the substrate 140 may be positioned in the internal space surrounded by the bottom portion 152 and the sidewall portion 154 of the substrate support frame 150.

In an embodiment of the present disclosure, the inner space formed in the substrate support frame 150 is referred to as a second internal space 155 to be distinguished from the first internal space 123 of the housing 120. A protrusion portion 158 may be formed inside the second internal space 155 of the substrate support frame 150 to support the antenna chip 160 mounted on the substrate 140. The protrusion portion 158 may protrudes from the bottom portion 152 of the substrate support frame 150 toward the antenna chip 160.

The protrusion portion 158 protrudes inward from the bottom portion of the substrate support frame 150, and an upper surface of the protrusion 158 is in contact with the antenna chip 160 to support the antenna chip 160. Accordingly, the antenna chip 160 may be stably positioned inside the housing 120.

Meanwhile, as shown in FIG. 3, one or more position fixing grooves 157 are formed at a position corresponding to the position fixing groove 147 formed in the substrate 140 on the outer surface of the substrate support frame 150. The position fixing grooves 157 are arranged to be aligned with each other in an y-axis direction of FIG. 3.

In addition, a terminal accommodation groove 159 is formed on the outer surface of the substrate support frame 150 in the x-axis direction so as not to interfere with the coupling of the terminal unit 129 to the substrate 140. For example, the terminal accommodation groove 159 may be formed in an y-direction of FIG. 3.

According to an embodiment of the present disclosure, the radome 110 is coupled to the housing 120 while the antenna module 130, the substrate 140, and the substrate support frame 150 are mounted inside the housing 120, such that the radar module assembly 100 can have a compact structure as shown in FIG. 5.

In more detail, as shown in FIG. 5, since the generally rectangular plate-shaped antenna module 130, the substantially rectangular-shaped substrate 140, and the substrate support frame 150 are located inside the first internal space 123 of the housing 120, and the substrate 140 is directly connected to the terminal unit 129 formed at or in the housing 120 and connected to the external terminal connection portion 128 outside the housing 120, the size of a structure of the radar module assembly 100 may be reduced.

As shown in FIG. 6, the radar module assembly 100 according to one embodiment of the present disclosure generates signals directly from the radar SoC and transmits and receives the signals through the feeding hole 145, the waveguide 135, and the antenna slot 138 through the transmitter 164 and the receiver 162, so that a distance from the antenna chip 160 to the antenna slot 138 may be reduced, thereby improving the propagation distance and resolution of the signals while loss of the signals is reduced.

In addition, the structure in which the antenna module 130, the substrate 140, and the substrate support frame 150 arranged inside the housing 120 may be more simple and easy to be fastened, so that the radar module assembly 100 may be manufactured at a lower cost.

As another embodiment of the present disclosure, a radar module assembly may be configured using an indirect feeding-type antenna chip instead of a direct feeding-type radar SoC. Hereinafter, a radar module assembly according to a second embodiment of the present invention will be described.

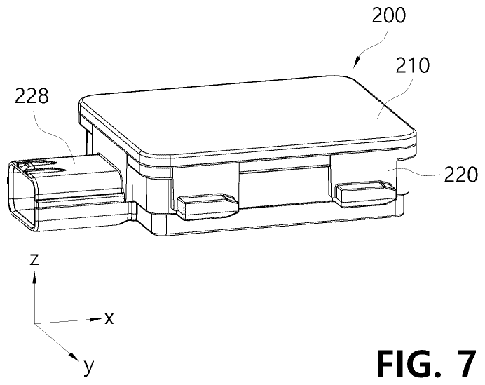

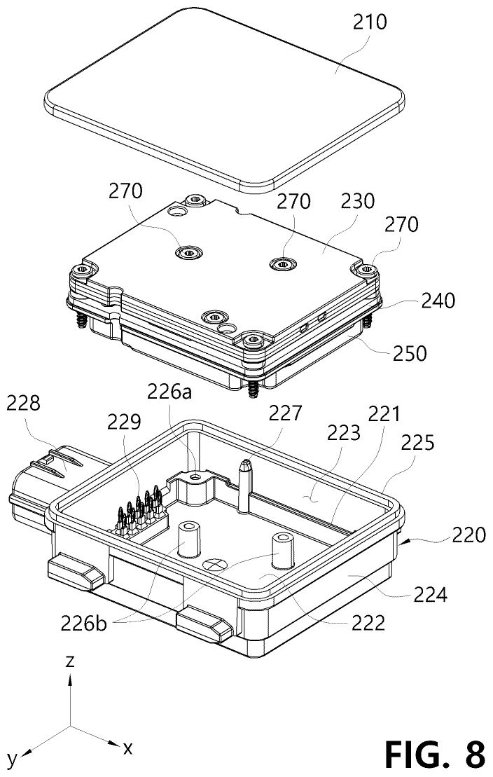

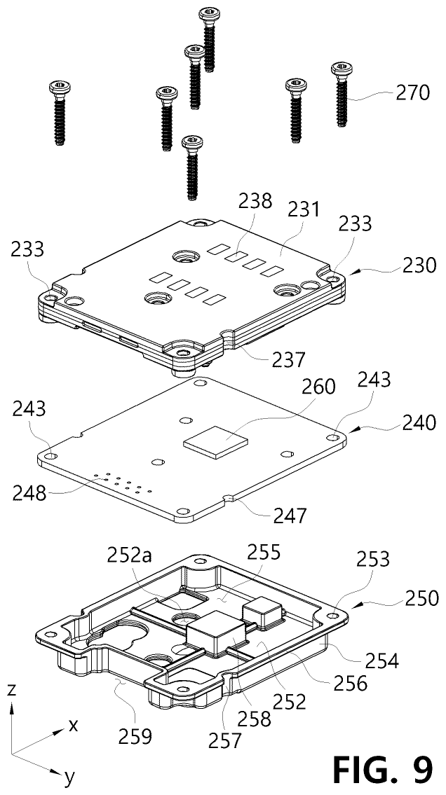

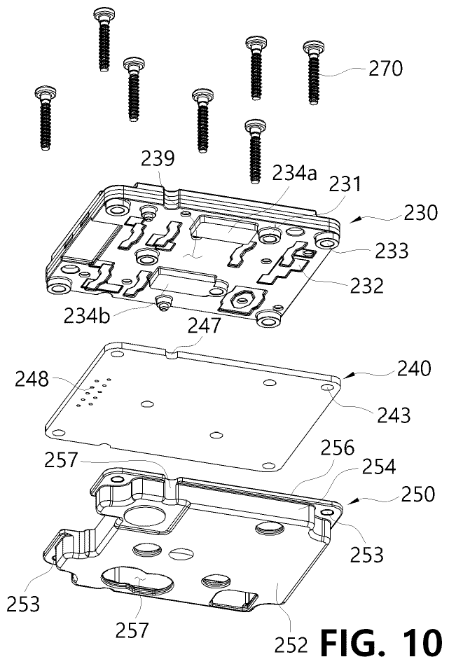

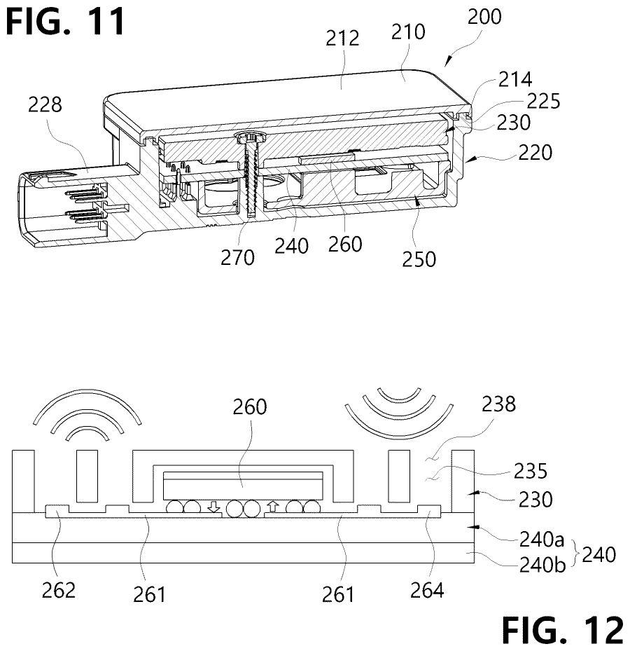

FIG. 7 is a perspective view of the radar module assembly according to a second embodiment of the present disclosure. FIG. 8 is an exploded perspective view of a radar module assembly according to the second embodiment of the present disclosure. FIG. 9 is an exploded top perspective view of an antenna module of the radar module assembly according to the second embodiment of the present disclosure. FIG. 10 is an exploded bottom perspective view of an antenna module of a radar module assembly according to the second embodiment of the present disclosure. FIG. 11 is a cross-sectional view of the radar module assembly according to the second embodiment of the present disclosure. FIG. 12 is a schematic configuration diagram for describing an operation of the radar module assembly according to the second embodiment of the present disclosure.

Referring to FIGS. 7 to 12, a radar module assembly 200 according to the second embodiment of the present disclosure may include a housing 220, an antenna module 230, a substrate 240, a substrate support frame 250, and a radome 210.

Referring to FIGS. 7 and 8, similar to the radar module assembly according to the first embodiment of the present disclosure, the radar module assembly 200 according to the second embodiment of the present disclosure may be modularized by fastening the antenna module 230, the substrate 240, and the substrate support frame 250 by a fastner or fastening member such as a bolt. In other words, the antenna module 230, the substrate 240, and the substrate support frame 250 of the radar module assembly 200 may be assembled to be a single module using the fastener 270.

In this case, the modularized antenna module 230, the substrate 240, and the substrate support frame 250 may be embedded in the radome 210 and the housing 220 to form the outer structure of the radar module assembly 200.

For example, in the second embodiment of the present disclosure, similar to the first embodiment, the housing 220 may have a substantially hexahedral shape and may be formed of a synthetic resin material such as plastic, similar to the first embodiment.

Referring to FIGS. 8 and 11, in the second embodiment of the present disclosure, the housing 220 includes a substantially rectangular plate-shaped bottom/base portion 222 forming the bottom surface of the housing 220 and a sidewall portion 224 extending upward from four sides or corners of the bottom/base portion 222 to form four sidewalls of the radar module assembly 200.

A radome coupling portion 225 protruding upwardly to be coupled to a side coupling portion of the radome 210 is formed to protrude from the upper end of the sidewall portion 224 of the housing 220. The protrusion of the radome coupling part 225 may be continuously formed along an upper circumference of the housing sidewall portion 224 so that the inside of the housing 220 can be watertight.

Referring to FIG. 8, a first internal space 223 in which the antenna module 230, the substrate 240, and the substrate support frame 250 may be disposed is formed inside the housing 220.

One or more position fixing protrusions 227 are formed on the inner surface of the sidewall portion inside the housing so that the antenna module 230, the substrate 240, and the substrate support frame 250 are securely positioned in the first internal space 223 by being supported by the position fixing protrusions 227 without being movable.

For example, the position fixing protrusions 227 are formed in a bar shape extending in the z-axis direction in FIG. 8 and protrude from the inside of the housing 220.

Position fixing grooves 237, 247, and 257 are formed on the side surfaces of the antenna module 230, the substrate 240, and the substrate support frame 250, respectively, corresponding to the position where the position fixing protrusions 227 of the housing 220 are formed. Such a structure may be the same as or similar to the structure described in the first embodiment.

In the second embodiment of the present disclosure, a terminal unit 229 is located at one side of the first internal space 223 of the housing 220. The terminal unit 229 includes a plurality of pins as shown in FIGS. 8 and 11, and first portions (e.g. one end portions) of the plurality of pins of the terminal unit 229 protrude upward from the first internal space 223 of the housing 220 (e.g. one side end of the first internal space 223 of the housing 220 with respect to the x-axis direction in FIG. 8).

Second portions (e.g. second end portions) of the plurality of pin of the terminal unit 229 protrude outwardly from the housing 220 through an external terminal connection portion 228 as shown in FIG. 11.

According to an embodiment of the present disclosure, when the antenna module 230, the substrate 240, and the substrate support frame 250 are mounted in the first internal space 223 of the housing 220, a terminal coupling hole 248 of the substrate 240 may be coupled to the terminal unit 229, and accordingly, the substrate 240 may be electrically connected to an external device located outside the housing 220 through the external terminal connection portion 228. Such a structure may be the same as or similar to the structure described in the first embodiment.

In the second embodiment of the present disclosure, a fastner coupling groove or fastening member coupling groove 226a is formed at four corners of the first internal space 223 of the housing 220 so that the fastner or fastening member 270 for coupling the antenna module 230, the substrate 240, and the substrate support frame 250 may be stably coupled to the inside of the first internal space 223 of the housing 220.

In this case, according to the second embodiment of the present disclosure, one or more fastner coupling protrusions or fastening member coupling protrusions 226b are formed to protrude from the bottom surface 222 of the housing 220. Unlike the first embodiment, the fastner coupling protrusions or fastening member coupling protrusions 226b according to the second embodiment may not be located in the central portion of the bottom/base portion 222 and, as shown in FIG. 8, the plurality of fastening member coupling protrusions 226b are spaced apart from each other.

In the second embodiment of the present disclosure, the fastner or fastening member 270 penetrating four corners of the antenna module 230, the substrate 240, and the substrate support frame 250 may be coupled to the fastner coupling groove or fastening member coupling groove 226a formed at four corners inside the first internal space 223 of the housing 220.

In addition, the fastner or fastening member 270 penetrating the antenna module 230, the substrate 240, and the substrate support frame 250 may be also coupled to one or more fastner coupling protrusions or fastening member coupling protrusions 226b protruding from the bottom surface 222 of the housing 220.

In this case, the fastening member coupling grooves 226a formed at the four corners are formed with a hole into which the fastening member 270 may be inserted at a height spaced at a predetermined height upward from the bottom surface 222 of the housing 220, and stepped portions 221 are formed on the inner surface of the sidewall portions 224 of the housing 220 at a same height as an end of the fastner coupling grooves or fastening member coupling grooves 226a.

The stepped portions 221 support the edge portion 256 formed along the outer circumference of the substrate support frame 250 in a state where the substrate support frame 250 is coupled to the first internal space 223 of the housing 220. Accordingly, the substrate support frame 250 may be stably supported without shaking in the first internal space 223 of the housing 220. Such a structure may be configured in the same manner as in the first embodiment.

Referring to FIGS. 8 and 11, the radome 210 may be a cover covering the antenna module 230, and the radome 210 may have an electrical insulating material. In the second embodiment of the present disclosure, the structure of the radome 210 may be formed in the same or similar manner as or to the structure of the radome 110 in the first embodiment, so the detailed description thereof will be replaced with the contents described in the first embodiment.

Referring to FIGS. 9 and 10, in the second embodiment of the present disclosure, the antenna module 230, the substrate 240, and the substrate support frame 250 are disposed inside the first internal space 223 of the housing 220 in a stacked manner.

Similar to the first embodiment, in the second embodiment of the present disclosure, the antenna module 230, the substrate 240, and the substrate support frame 250 may be coupled to the first internal space 223 of the housing 220 in a state where the antenna module 230, the substrate 240, and the substrate support frame 250 are integrally coupled by the fastner or fastening member 270. Alternatively, the antenna module 230, the substrate 240, and the substrate support frame 250 and the housing may be coupled by the fastening member 270 at the same time when coupled to the first internal space 223 of the housing 220.

Referring to FIGS. 9 to 11, the antenna module 230 according to the second embodiment of the present disclosure may include an antenna module body 231 which is a substantially rectangular plate-shaped structure. For example, the antenna module 230 may be formed of a synthetic resin material such as plastic, but any material can be used for the antenna module 230. In this case, a plating layer may be formed on the outer surface of the antenna module body 231.

In the second embodiment of the present disclosure, as shown in FIG. 9, a plurality of antenna slots 238 are formed on the upper surface of the antenna module 230. The plurality of antenna slots 238 are connected to a waveguide 235 positioned inside the antenna module 230 and a waveguide connection hole 234 formed in a lower surface of the antenna module 230.

For instance, the antenna slots 238 may have eight antenna slots, and four of the eight antenna slots 238 may be used for transmission, and the remaining other four of the eight antenna slots 238 may be used for reception. The shape, position, and number of the antenna slots may be variously changed depending on an antenna design of the radar module assembly 200.

Meanwhile, referring to FIG. 10, a pair of gap maintaining portions 234a and 234b protrude from a lower surface of the antenna module 230, that is, a surface adjacent to the substrate 240.

The pair of gap maintaining portions 234a and 234b protrude in order to maintain a constant distance between the substrate 240 on which the antenna chip 260 is mounted and one surface of a body of the antenna module 230. The pair of gap maintaining portions 234a and 234b are disposed to be spaced apart from each other on both sides of the chip accommodation space 239 in which the antenna chip 260 is mounted. The thickness of the pair of gap maintaining portions 234a and 234b (e.g. a thickness in the z-direction) may be thicker than the thickness of the antenna chip 260.

Meanwhile referring to FIG. 10, a plurality of feeding holes 232 are formed on the lower surface of the antenna module 230 which is a surface adjacent to the substrate 240. The plurality of feeding holes 232 are components formed to transmit signals transmitted and received from a feeding line formed in the substrate 240 to the antenna slot 238 through the waveguide 235.

In one embodiment of the present disclosure, the size and the positional shape of the feeding holes 232 may be designed in various ways in consideration of the position of the feeding line 261 formed in the substrate 240.

In the second embodiment of the present disclosure, the antenna module 230 may be manufactured by a method of stacking a plurality of plate members made of plastic in order to manufacture the antenna module 230 having the feed holes 232, a waveguide 235 passing inside the antenna module 230, and an antenna slot 238. However, the manufacturing method of the antenna module 230 is not limited thereto, and, for instance, the antenna module 230 may be manufactured using 3D printing or in various known methods.

In this case, the inside of the antenna slot 238, the waveguide 235, and the feeding hole 232 is plated with metal to smoothly transmit and receive signals when the signals passing through the waveguide 235 are transmitted to the outside of the radar module assembly 200 through the antenna slot 238 from the feeding hole 232 or received from the outside of the radar module assembly 200.

Meanwhile, as shown in FIG. 9, the position fixing grooves 237 are formed on both sides of the antenna module 230 to face each other. For instance, the position fixing grooves 237 are arranged to be aligned with each other in an y-axis direction of FIG. 9.

Meanwhile, in one embodiment of the present disclosure, referring to FIG. 11, the substrate 240 coupled to the lower portion of the antenna module 230 may be formed by stacking the Radio Frequency (RF) Printed Circuit Board (PCB) substrate 240a and the PCB substrate 240b made of a woven fiberglass such as fiberglass-reinforced epoxy laminate material (FR4) material.

In this case, a radar SoC antenna chip 260 is mounted on the upper portion of the RF PCB substrate 240a, and a plurality of feeding lines 261 are formed to outwardly extend from the antenna chip 260.

A transmission terminal 264 for transmitting signals or a reception terminal 262 for receiving signals may be formed at each end side of the plurality of feeding lines 261.

In this case, each end portion of the feeding lines 261 are located below the feeding holes 232 of the antenna module 230. In an embodiment of the present disclosure, the substrate 240 coupled to the lower portion of the antenna module 230 is formed by stacking the RF PCB substrate 240a and the substrate 240b made of the woven fiberglass such as FR4 material, thereby reducing the cost of manufacturing the radar and simplifying the structure of the radar module assembly 200.

In the second embodiment of the present disclosure, unlike the first embodiment, the RF PCB substrate 240a is stacked without using only a FR4 material PCB substrate, and the radar module assembly 200 is configured by an indirect feeding method, however, in order to reduce the height of the radar module assembly 200, the antenna chip 260 is disposed between the antenna module 230 and the substrate 240, and therefore the thickness of the antenna module 230 can reduced to make the structure of the radar module assembly 200 compact.

In this case, the method of extending the feeding lines 261 to the periphery of the antenna chip 260 so that they can be fed in the indirect feeding method may have a slightly lower transmission/reception distance or resolution than the direct feeding method.

Meanwhile, as shown in FIG. 9, the terminal coupling hole 248 for being coupled to the terminal unit 229 is formed at one end side of the substrate 240 (e.g. an end portion in the x-axis direction of FIG. 9). In addition, a position fixing groove 247 is formed on both sides of the substrate 240 at a position corresponding to the position fixing groove 237 of the antenna module 230. The position fixing grooves 247 are arranged to be aligned with each other in an y-axis direction of FIG. 9. Such a structure according to the second embodiment may be formed the same as or similar to the configuration of the first embodiment.

Meanwhile, according to the second embodiment of the present disclosure, a substrate support frame 250 is provided to support the substrate 240 and the antenna chip 260 mounted on the substrate 240.

Referring to FIGS. 9 and 10, the substrate support frame 250 includes a bottom portion 252 formed of a rectangular plate structure or member to form a bottom surface and a sidewall portion 254 protruding from four sides or corners of the bottom portion 252 in the z-axis direction to form a side wall of surface of the radar module assembly 200. An edge portion 256 is formed at an upper end portion of the sidewall portion 254. The edge portion 256 extends in a direction perpendicular to the sidewall portion 254, such as an y-direction in FIG. 9.

In an embodiment of the present disclosure, the substrate 240 is coupled to the substrate support frame 250 by the fastner or fastening member 270 while an edge portion of the substrate 240 is in contact with the edge portion 256 of the substrate support frame 250.

Fastening holes 253 are formed at the edge portion 256 of the substrate support frame 250, for example, four corners of the substrate support frame 250 where the edge portion 256 of the substrate support frame 250 is formed, so that the fastner or fastening member 270 may be coupled through the fastening holes 253 of the substrate support frame 250.

Meanwhile, one or more through hole 252a are formed at a central portion of the bottom portion 252 of the substrate support frame 250 so that the fastner coupling protrusion or fastening member coupling protrusion 226b formed at the bottom portion 222 of the housing 220 protrudes and penetrates through the through hole 252 of the substrate support frame 250. Such a structure may be formed in the same or similar manner as or to the structure in the first embodiment.

Accordingly, in an embodiment of the present disclosure, the bottom portion 252 of the substrate support frame 250 may be mounted inside the first internal space 223 of the housing 220, and be fixed to and be in contact with the bottom portion 222 of the housing 220.

In the first embodiment of the present disclosure, the antenna chip 160 mounted on the substrate 140 is positioned in the second internal space 155 surrounded by the bottom portion 152 and the sidewall portion 154 of the substrate support frame 150. However, in the second embodiment of the present disclosure, the antenna chip 260 is mounted between the substrate 240 and the antenna module 230, so that the antenna chip 160 cannot be positioned in the second internal space 155.

As shown in FIGS. 9 and 11, in the second embodiment of the present disclosure, a protrusion portion 258 may be formed inside the second internal space 255 of the substrate support frame 250 to support the opposite surface of the substrate 240 on which the antenna chip 260 is mounted. Accordingly, the antenna chip 260 may be stably positioned inside the housing. The protrusion portion 258 may protrudes from the bottom portion 252 of the substrate support frame 250 toward the antenna chip 260.

Meanwhile, as shown in FIG. 9, one or more position fixing grooves 257 are formed at a position corresponding to the position fixing groove 247 formed in the substrate 240 on the outer both surfaces of the substrate support frame 250. The position fixing grooves 257 are arranged to be aligned with each other in an y-axis direction of FIG. 9.

In addition, a terminal accommodation groove 259 is formed on the end side of the substrate support frame 250 in the x-axis direction so as not to interfere with the coupling of the terminal unit 229 to the substrate 240. For example, the terminal accommodation groove 259 may be formed in a y-direction of FIG. 9. Such a structure may be configured the same as or similar to the structure in the first embodiment.

According to the second embodiment of the present disclosure, the radome 210 is coupled to the housing 220 while the antenna module 230, the substrate 240, and the substrate support frame 250 are mounted inside the housing 220, such that the radar module assembly 200 can have a compact structure as shown in FIG. 11.

In more detail, as shown in FIG. 10, since the generally rectangular plate-shaped antenna module 230, the substantially rectangular-shaped substrate 240, and the substrate support frame 250 are located inside the first internal space 223 of the housing 220, and the substrate 240 is directly connected to the terminal unit 229 formed at or in the housing 220 and connected to the external terminal connection portion 228 outside the housing 220, the size of a structure of the radar module assembly 200 may be reduced.

As shown in FIG. 12, the radar module assembly 200 according to an embodiment of the present disclosure may transmit and receive signals from the radar SoC to the outside of the antenna chip 260 through the feeding line, and transmit and receive the signals to and from the outside of the antenna chip 260 through the feeding hole 232, the waveguide 235 and the antenna slot 238. Therefore, the thickness of the antenna module 230 can be reduced so that the radar module assembly 200 may have a more compact structure.

In addition, the structure in which the antenna module 230, the substrate 240, and the substrate support frame 250 arranged inside the housing 220 may be more simple and easy to be fastened, so that the radar module assembly may be manufactured at a lower cost.

Therefore, a radar module assembly according to some embodiments of the present disclosure may have a more compact structure because it includes a thinner waveguide antenna module by manufacturing an antenna module in a plate shape using a synthetic resin material and forming a waveguide therein.

According to certain embodiments of the present disclosure, a radar module assembly may be coupled to a antenna module by stacking an antenna chip capable of directly feeding on a substrate such as a fiberglass-reinforced epoxy laminate material (FR4) PCB substrate, thereby enabling direct feeding.

According to some embodiments of the present disclosure, a radar module assembly may be assembled in a more simple structure by directly coupling an antenna module, a substrate on which a chip is mounted, and a substrate support frame supporting the substrate to a housing of the radar module assembly.

According to certain embodiments of the present disclosure, a radar module assembly may be manufactured in an indirect feeding method by stacking a RF PCB substrate and a fiberglass-reinforced epoxy laminate material (FR4) PCB substrate to form a substrate, so that the radar module assembly can have a more compact structure.

According to some embodiments of the present disclosure, in a radar module assembly, a PCB substrate may be coupled to a terminal unit formed in a housing to be electrically connected to the outside of the housing through the terminal unit, such that the radar module assembly can have a more compact structure.

A radar module assembly according to certain embodiments of the present disclosure may have an antenna chip support structure capable of safely supporting an antenna chip configured to generate a radar signal inside a housing after mounting the antenna chip on a substrate, thereby stably generating a signal.

It should be understood that the effects of the present disclosure are not limited to the above-described effects and include all effects inferable from a configuration of the invention described in detailed descriptions or claims of the present disclosure. Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A radar module assembly comprising:
a housing having an internal space;
an antenna module disposed inside the internal space of the housing;
a substrate disposed to face one surface of the antenna module and disposed inside the internal space of the housing, wherein an antenna chip is mounted to the substrate to transmit or receive a signal through the antenna module; and
a radome coupled to the housing to cover the internal space of the housing, wherein the radome is disposed to face another surface of the antenna module opposite to the one surface of the antenna module which the substrate faces.

2. The radar module assembly of claim 1, wherein the antenna chip is a single chip in which a radio frequency integrated circuit (RFIC) and a micro-controller unit (MCU) are integrated.

3. The radar module assembly of claim 2, wherein:
the antenna chip is mounted on one surface of the substrate opposite to another surface of the substrate to which the antenna module is coupled, and
the substrate has a feeding hole through which the signal is directly fed from the antenna chip to the antenna module.

4. The radar module assembly of claim 3, wherein the substrate includes a printed circuit board (PCB) substrate made of fiberglass-reinforced epoxy laminate (FR4) material.

5. The radar module assembly of claim 3, wherein:
the antenna module includes an antenna module body in which a waveguide is comprised,
one end of the waveguide is connected to a waveguide connection hole formed in the antenna module body and connected to the feeding hole, and
another end of the waveguide is connected to an antenna slot formed on the another surface of the antenna module facing the radome.

6. The radar module assembly of claim 1, wherein the antenna chip is mounted on one surface of the substrate facing the antenna module.

7. The radar module assembly of claim 6, further comprising a gap maintaining portion thicker than the antenna chip, wherein the gap maintaining portion is positioned on the one surface of the antenna module facing the substrate to form a gap between the antenna module and the substrate.

8. The radar module assembly of claim 6, wherein the substrate includes:
a radio frequency (RF) PCB substrate facing the antenna module and
a FR4 PCB substrate stacked on the RF PCB substrate.

9. The radar module assembly of claim 1, further comprising:
a substrate support frame supporting the substrate in the internal space of the housing, and
a fastener coupling the antenna module and the substrate to the substrate support frame.

10. The radar module assembly of claim 9, wherein the substrate support frame includes:
a base portion having a plate shape and contacting an inner surface of the internal space of the housing; and
a sidewall portion protruding toward the substrate from the base portion, and
wherein an edge portion of the substrate is supported by the sidewall portion of the substrate support frame.

11. The radar module assembly of claim 9, wherein the fastner couples the antenna module, the substrate, and the substrate support frame to an inside of the internal space of the housing.

12. The radar module assembly of claim 9, wherein:
a position fixing groove is formed on one side portion of the antenna module, the substrate, and the substrate support frame, and
a position fixing protrusion is formed on a sidewall portion of the internal space of the housing at a position corresponding to the position fixing groove.

13. The radar module assembly of claim 1, wherein:
a terminal unit is formed at one side of the internal space of the housing, and
one portion of the terminal portion protrudes to an external terminal connection portion formed at an outside of the housing, and
another portion of the terminal portion is electrically connected to the substrate.

14. A radar module assembly comprising:
a housing having a internal space;
an antenna module assembly disposed inside the internal space of the housing; and
a radome coupled to the housing to cover the internal space of the housing,
wherein the antenna module assembly includes:
an antenna module;
a substrate disposed to face one surface of the antenna module and disposed inside the internal space of the housing, wherein an antenna chip is mounted to the substrate to transmit or receive a signal through the antenna module; and
a substrate support frame supporting the substrate in the internal space of the housing,
wherein the radar module assembly further comprises a fastner coupling the antenna module, the substrate, and the substrate support frame.

15. The radar module assembly of claim 14, wherein the antenna chip is a single chip in which a radio frequency integrated circuit (RFIC) and a micro-controller unit (MCU) are integrated.

16. The radar module assembly of claim 14, wherein the antenna chip is mounted on one surface of the substrate facing the antenna module.

17. The radar module assembly of claim 14, wherein the substrate support frame includes:
a base portion having a plate shape and contacting an inner surface of the internal space of the housing; and
a sidewall portion protruding toward the substrate from the base portion, and
wherein an edge portion of the substrate is supported by the sidewall portion of the substrate support frame.

18. The radar module assembly of claim 14, wherein the fastner couples the antenna module, the substrate, and the substrate support frame to an inside of the internal space of the housing.

19. The radar module assembly of claim 14, wherein:
a position fixing groove is formed on one side portion of the antenna module, the substrate, and the substrate support frame, and
a position fixing protrusion is formed on a sidewall portion of the internal space of the housing at a position corresponding to the position fixing groove.

20. The radar module assembly of claim 14, wherein:
a terminal unit is formed at one side of the internal space of the housing, and
one portion of the terminal portion protrudes to an external terminal connection portion formed at an outside of the housing, and
another portion of the terminal portion is electrically connected to the substrate.
